(19) United States
(12) Patent Application Publication
(10) Pub. No.: US 2009/0075801 A1
(43) Pub. Date: Mar. 19, 2009

(54) COUNTER-CENTRIFUGAL FORCE DEVICE

(76) Inventors: Dalibor Hodko, Poway, CA (US); Dan Smolko, San Diego, CA (US); Paul Swanson, Santee, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/233,935

(22) Filed: Sep. 19, 2008

Related U.S. Application Data
(60) Provisional application No. 60/994,613, filed on Sep. 19, 2007.

(51) Int. Cl. B04B 5/06

(52) U.S. Cl. 494/22; 494/37

(57) ABSTRACT

Disclosed herein are integrated microfluidic devices and methods of using the devices for large panel detection and multi-step procedures within a single, enclosed structure. The methods and devices provided herein are capable of two-dimensional and three-dimensional fluid pumping along a disc surface and among multiple discs. In an embodiment, one or more pumps are used to propel sample in a direction opposite the direction of centrifugal force such that sample flows both radially outward and radially inward relative to the disc's axis of rotation. This effectively provides an increase in usable disc space for the flow of sample. The disclosed devices and methods reduce, minimize, or eliminate the surface area limitation of known integrated microfluidic devices. Thus, the disclosed devices provide increased usable surface area of a rotating disc structure.

### REFERENCE TO PRIORITY DOCUMENT

This application claims priority of co-pending U.S. Provisional Patent Application Ser. No. 60/994,613, filed Sep. 19, 2007. Priority of the aforementioned filing date is hereby claimed and the disclosure of the Provisional patent application is hereby incorporated by reference in its entirety.

### STATEMENT OF GOVERNMENT INTEREST

This work was supported by NIH Grant No. 5R44AI052977 awarded by the National Institutes of Health. The United States government has certain rights to the invention.

### BACKGROUND

Advances in microfluidic technology and the development of microfluidics-based devices have miniaturized laboratory instruments and integrated laboratory applications. One type of microfluidics device is based on microchannels formed in a rotatable disc. Such a device, sometimes called a “centrifugal rotor”, “lab on a chip” or “CD device” can be used to perform procedures with small quantities of fluids (see for example, those described in U.S. Pat. Nos. 5,006,749; 5,252,294; 5,304,487; 5,368,704; 6,527,432; 6,620,478; 6,709,869; 6,719,682; 6,884,395 and 6,919,058; International Application Publication Nos. WO93/22053; WO93/22058; WO 02/074438 and WO 99/58245).

Centrifugal microfluidic devices in laboratory applications generate centripetal acceleration by rotating a disc that enables fluid movement through microchannels in the disc. The rotation and centripetal acceleration create a centripetal force radially directed towards the disc center. A resulting centrifugal force moves fluids inside the disc towards the outer diameter or perimeter of the disc.

Although centrifugal microfluidic devices provide fast, portable and cost effective methods of processing multiple samples in parallel, the throughput of such devices are limited by the number of microchannel structures that fit on the disc surface. The available surface area of known devices limits their use for laboratory applications, such as DNA isolation and sequencing, which involve a large number of sequential steps. Further, the limited surface area restricts their use in the analysis and detection of large pathogen panels. For example, specific detection of biological warfare pathogens and toxins could include panels with 80 or more members. Similarly, panels for respiratory disease and emerging viruses involve large number of members.

### SUMMARY

In view of the foregoing, there is a need for an integrated microfluidic device that can be used for large panel detection and multi-step procedures within a single, enclosed structure. Provided herein are devices and methods of using the devices, devices capable of two-dimensional and three-dimensional fluid pumping along a disc surface and among multiple discs. In an embodiment, one or more pumps are used to propel sample in a direction opposite the direction of centrifugal force such that sample flows both radially outward and radially inward relative to the disc's axis of rotation. This effectively provides an increase in usable disc space for the flow of sample. The disclosed devices and methods reduce, minimize, or eliminate the surface area limitation of known integrated microfluidic devices. Thus, the disclosed devices provide increased usable surface area of rotating disc structure.

In one embodiment, the device includes a platform having an axis of rotation and one or more fluidic structures, each fluidic structure having an inlet port near the axis of rotation; a first reservoir located away from the axis of rotation; and a second reservoir located near the axis of rotation. The first reservoir fluidly communicates with the inlet port via a first conduit and the first reservoir fluidly communicates with the second reservoir via a second conduit. The platform also includes one or more pumps in fluid communication with the one or more fluidic structures via a third conduit. The fluid loaded in the inlet port moves through the first conduit to the first reservoir by centrifugal force arising from the platform rotating around the axis. The fluid moves from the first reservoir through the second conduit to the second reservoir by a counter-centrifugal force generated by the pump, and wherein fluid movement toward the first reservoir comprises movement away from the axis of rotation and fluid movement toward the second reservoir comprises movement toward the axis of rotation.

Also disclosed herein is an embodiment of a method of preparing a sample for analysis including loading a sample onto a platform. The platform includes an axis of rotation, one or more fluidic structures, and one or more pumps in fluid communication with the one or more fluidic structures. The sample is loaded in an inlet port near the axis of rotation. The method also includes rotating the platform about its axis of rotation generating a centrifugal force. The force moves the sample through the one or more fluidic structures to a first reservoir away from the axis of rotation. The method also includes generating a pressure differential within the one or more fluidic structures to move the sample toward the axis of rotation through the one or more fluidic structures against the centrifugal forces generated by rotating the platform.

Also disclosed herein is an embodiment of a method of preparing a sample for analysis that includes loading a sample into the inlet port of a device described herein. The method includes rotating the device about its axis of rotation to move the sample through a first conduit to a first reservoir located away from the axis of rotation by centrifugal force arising from the device rotating around the axis. The method also includes creating a counter-centrifugal force with a pump to move the sample from the first reservoir through a second conduit to a second reservoir located near the axis of rotation.

Other features and advantages should be apparent from the following description of various embodiments, which illustrate, by way of example, the principles of the invention.

### BRIEF DESCRIPTION OF DRAWINGS

According to common practice, the various features of the drawings may not be presented to-scale. Rather, the dimensions of the various features may be arbitrarily expanded or reduced for clarity. Included in the drawings are the following figures:

FIG. 1 shows a schematic diagram of one embodiment of a counter-centrifugal force device.

FIG. 2 shows a schematic diagram of fluid structures and pumps of the device of FIG. 1.

FIG. 3 shows a schematic diagram of one embodiment of an on-disc pumping mechanism.

FIG. 4 shows a top plan view of one embodiment of the device.

FIG. 5 shows an exploded, schematic view of one embodiment of a three-dimensional compact disc (3D-CD) device.

FIGS. 6A-6E show top plan views demonstrating flow through fluid structures and operation of electrochemical pumps in combination with centrifugal pumping on the 3DCD device.

### DETAILED DESCRIPTION

Before the present subject matter is further described, it is to be understood that this subject matter described herein is not limited to particular embodiments described, as such may of course vary. It is also to be understood that the terminology used here in is for the purpose of describing particular embodiments only, and is not intended to be limiting. Unless defined otherwise, all technical terms used herein have the same meaning as commonly understood by one skilled in the art to which this subject matter belongs.

Where a range of values is provided, it is understood that each intervening value, to the tenth of the unit of the lower limit, unless the context clearly dictates otherwise, between the upper and lower limit of that range, and any other stated or intervening value in that stated range, is encompassed within the subject matter described herein. The upper and lower limits of these smaller ranges may independently be included in the smaller ranges, and are also encompassed within the subject matter described herein, subject to any specifically excluded limit in the stated range. Where the stated range includes one or both of the limits, ranges excluding either or both of those included limits are also included in the subject matter described herein.

It must be noted that as used herein and in the appended claims, the singular forms “a”, “and”, and “the” include plural referents unless the context clearly dictates otherwise. Thus, for example, reference to a “fastener” includes a plurality of such fasteners, and reference to “the engagement element” includes reference to one or more engagement elements and equivalents thereof known to those skilled in the art, and so forth.

It is further noted that the claims may be drafted to exclude any optional element. As such, this statement is intended to serve as antecedent basis for use of such exclusive terminology as “solely”, “only” and the like, in connection with the recitation of claim elements, or the use of a “negative” limitation. Accordingly, the term “optional” or “optionally present”—as in an “optional element” or an “optionally present element” means that the subsequently described element may or may not be present, so that the description includes instances where the element is present and instances where it is not.

Provided herein are methods and devices for manipulation and preparation steps of biological, chemical, environmental, medical, forensic and industrial samples for performing microanalytical and microsynthetic assays. The device is a small, portable, disposable analysis system that is capable of processing a large sample panel (e.g. up to 20 or more samples per disc) thereby providing a system for rapid preparation and/or analysis of multiple samples. The device includes a platform that contains microfluidic systems of closed interconnected networks of channels and reservoirs. The platform rotates to generate centripetal acceleration and centrifugal force to achieve fluid movement through the network of channels and reservoirs. One or more electrochemical and/or chemical pumps can be used to achieve fluid movement in a direction counter to that achieved by rotation of the platform. That is, electrochemical pumps and/or chemical pumps can be used to achieve fluid movement on the disc in a direction counter to the centrifugal force. This permits an increase in the available surface area of the device for fluid channels. Fluidic separations from two dimensions into a third dimension further extend the available surface area of the device, as described in detail below. Extending the available surface area of the device allows for greater number of samples to be manipulated and/or a greater number of steps that can be performed with the device.

Unless defined otherwise, all technical and scientific terms used herein have the same meaning as is commonly understood by one of ordinary skill in the art. All patents, applications, published applications and other publications referred to herein are incorporated by reference in their entirety.

As used herein, “sample” refers to any fluid, solution or mixture, either isolated or detected as a constituent of a more complex mixture, or synthesized from precursor species. In general, a biological sample can be any sample taken from a subject, e.g., non-human animal or human and utilized in the device. For example, a biological sample can be a sample of any body fluid, cells, or tissue samples from a biopsy. Body fluid samples can include without any limitation blood, urine, sputum, semen, feces, saliva, bile, cerebral fluid, nasal swab, urogenital swab, nasal aspirate, spinal fluid, etc. Biological samples can also include any sample derived from a sample taken directly from a subject, e.g., human. For example, a biological sample can be the plasma fraction of a blood sample, serum, protein or nucleic acid extraction of the collected cells or tissues or from a specimen that has been treated in a way to improve the detectability of the specimen, for example, a lysis buffer containing a mucolytic agent that breaks down the mucens in a nasal specimen significantly reducing the viscosity of the specimen and a detergent to lyse the virus thereby releasing antigens and making them available for detection by the assay. A sample can be from any subject animal, including but not limited to, human, bird, porcine, equine, bovine, murine, cat, dog or sheep.

For example, a sample can be derived from any source, such as a physiological fluid, including blood, serum, plasma, saliva or oral fluid, sputum, ocular lens fluid, nasal fluid, nasopharyngeal or nasal pharyngeal swab or aspirate, sweat, urine, milk, ascites fluid, mucous, synovial fluid, peritoneal fluid, transdermal exudates, pharyngeal exudates, bronchoalveolar lavage, tracheal aspirations, cerebrospinal fluid, semen, cervical mucus, vaginal or urethral secretions, amniotic fluid, and the like. Herein, fluid homogenates of cellular tissues such as, for example, hair, skin and nail scrapings and meat extracts are also considered biological fluids. Pretreatment may involve preparing plasma from blood, diluting or treating viscous fluids, and the like. Methods of treatment can involve filtration, distillation, separation, concentration, inactivation of interfering components, and the addition of reagents. Besides physiological fluids, other samples can be used such as water, food products, soil extracts, and the like for the performance of industrial, environmental, or food production assays as well as diagnostic assays. In addition, a solid material suspected of containing the analyte can be used as the test sample once it is modified to form a liquid medium or to release the analyte. The selection and pretreatment of biological, industrial, and environmental samples prior to testing is well known in the art and need not be described further.

Other fields of interest include the diagnosis of veterinary diseases, analysis of meat, poultry, fish for bacterial contamination, inspection of food plants, food grains, fruit, dairy products (processed or unprocessed), restaurants, hospitals and other public facilities, analysis of environmental samples including water for beach, ocean, lakes or swimming pool contamination. Analytes detected by these tests include viral and bacterial antigens as well as chemicals including, for example, lead, pesticides, hormones, drugs and their metabolites, hydrocarbons and all kinds of organic or inorganic compounds. Samples include biological, chemical, environmental, medical, forensic and industrial samples. Samples can also include air samples where the bio-aerosol is converted into a liquid, e.g. using wet cyclones.

As used herein, “fluid” refers to liquids or gases. “Fluidly connected” or “in fluid communication” refers to components that are operably interconnected to allow fluid flow between the components.

The device can include a platform having one or more microchannel structures in which fluids are transported or processed, the structures extending in a plane parallel or substantially parallel to the platform plane. As used herein, “platform” contemplates a circular disc such as a compact disc (CD), however the platform need not be circular and any platform capable of being rotated to impart centripetal acceleration is considered. The platform can be of the same dimension as conventional CDs, but can be smaller or larger. As used herein, “platform” and “disc” are considered to be interchangeable.

As used herein, “3D-CD” or “CD stack” refers to at least two platforms in fluid communication with one another, but can also include three, four, five or more platforms.

As used herein, “microchannels,” “channels,” “microconduit” and “conduit” are interchangeable and refer to the structure for fluid transport into or out of a microchannel structure and well as fluid transport within the microchannel structure. Microchannels and microconduits can have, for example, a cross-sectional form that is rounded, i.e. circular, ellipsoid, etc. A microchannel can also have inner edges, i.e. a cross-sectional form that is triangular, square, rectangular, partly rounded, planar etc. Microcavities and microchambers and microreservoirs can have the same or a different cross-sectional geometry compared to the surrounding structures.

As will be apparent to those of skill in the art upon reading this disclosure, each of the individual embodiments described and illustrated herein has discrete components and features which may be readily separated from or combined with the features of any of the other several embodiments without departing from the scope of the subject matter described herein. Any recited method can be carried out in the order of events recited or in any other order which is logically possible.

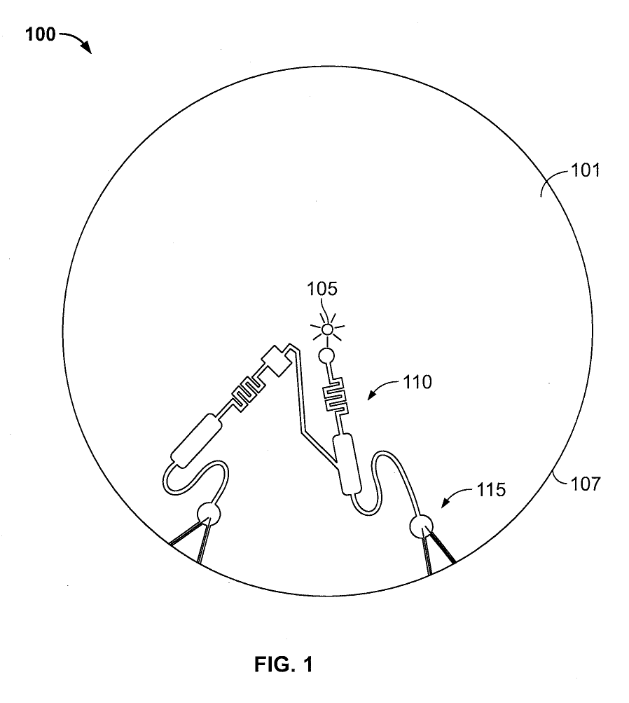

As shown in FIG. 1, an exemplary embodiment of the device 100 generally includes one or more microfluid structures 110 fluidly connected to one or more pumps 115 arranged on a platform 101. The platform 101 is shown in FIG. 1 as a generally circular disc with a hole 105 at a central axis of rotation that is perpendicular to the plane of the platform 101. The microfluid structures 110 and pumps 115 are shown as oriented from an inner position to an outer position in relation to the rotational axis of the platform 101 such that the structures extend radially outward from the hole 105. It should be appreciated that other platform shapes are considered and other arrangements of the microfluid structures 110 and pumps 115 are considered. The platform 101 rotates around the central hole 105 such that centrifugal force causes fluid in the microfluid structures 110 to flow towards the outer edge or periphery 107 of the platform 101. The pump 115 fluidly communicates with the microfluid structure 110 such that the pump 115 causes fluid to move through the microfluid structure 110 in a counter-centrifugal direction or away from the periphery of the platform 105, as described in detail below.

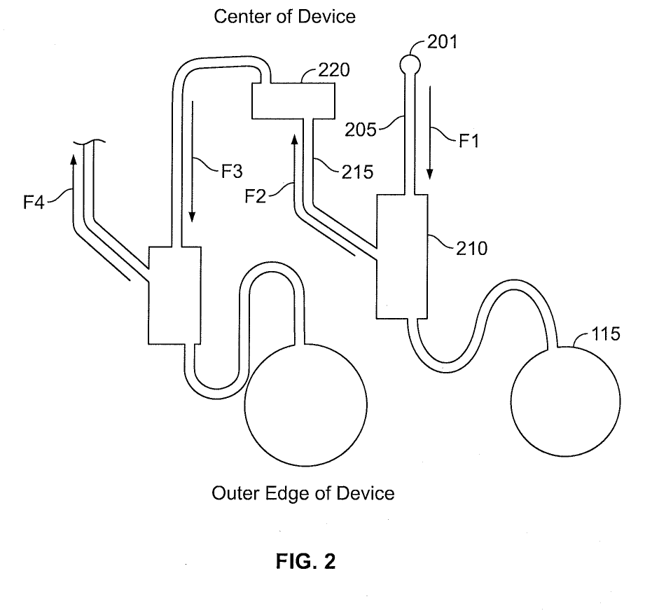

FIG. 2 shows a schematic diagram of a series of microfluid structures 110 in fluid communication with a pump 115. In the illustrated embodiment, the microfluid structures 110 are in sequential fluid communication with one another, although it should be appreciated that the microfluid structures 110 can also be fluidly independent of one another. Each microfluid structure 110 can include one or more functional units that carry out a predetermined protocol within the structure. For example, a microfluid structure 110 can include one or more units including inlet ports, outlet ports, units for distributing samples, fluids and/or reagents to individual microfluid structures, microconduits for fluid transport including waste cavities and overflow channels and the like. In one and the same microfluid structure 110 there can be several of these units. The microfluid structures 110 can be essentially identical or can be a series of different structures that perform different functions.

The microfluid structure 110 includes a network of reservoirs and conduits through which fluid flows. The fluid movement through the reservoirs and conduits is described with respect to the schematic diagram of FIG. 2. As mentioned, the microfluid structures 110 are oriented from an inner position to an outer position in relation to the rotational axis of the platform. Generally, the microfluid structure 110 includes an inlet port 201 fluidly connected to a reservoir 210 via a conduit 205. The inlet port 201 can be generally located near the center of the platform and the reservoir 210 more distal from the inlet port 201 toward the periphery of the platform. The inlet port 201 can be used as an application area for reagents and samples. The reagents and samples can be loaded manually or by automated techniques. The volume of reagents and samples that can be loaded can vary, but can be as low as pica-liter volumes.

The platform spins or rotates about the rotational axis to generate centrifugal force sufficient to drive fluid from the inlet port 201 radially outward toward the edge or perimeter of the device through the conduit 205. In an embodiment, rotation in the range of 10-20 seconds at 1,000 RMP (when using 4.72″ diameter discs) generates a level of centrifugal force sufficient to move sample out of the inlet port 201 and through the first conduit 205 toward the first reservoir 210. The direction of fluid flow generated by centrifugal force is identified in FIG. 2 by arrows F₁ and F₃. It should be appreciated that the rotational velocity can be varied to achieve various levels of fluid flow and that the rotational velocity is not limited to the specific ranges described herein.

The microfluid structure 110 can also include vents and waste outlets. The vents are open to the air via the top surface of the disc to allow fluid to freely move through the microfluid structures 110. One or more structures that enable valving, decanting, calibration, mixing, metering, sample splitting and separation can be incorporated into the microfluid structure 110. For example, hydrophobic and capillary valves can be incorporated into the structure. Fluid gating within the microfluid structure 110 can be accomplished using “capillary” valves in which capillary forces retain fluids at an enlargement in a channel until rotationally induced pressure is sufficient to overcome the capillary pressure at the so-called burst frequency (see, Madou et al., “The LabCD™: A Centrifuge-Based Microfluidic Platform for Diagnostics,” in Systems and Technologies for Clinical Diagnostics and Drug Discovery, vol. 3259, G. E. Cohn and A. Katzir, Eds. San Jose, Calif.: SPIE, 1998, pp. 80-93; [Ekstrand et al., “Microfluidics in a Rotating CD”, Micro Total Analysis Systems 2000, A. van den Berg, W. Olthuis, P. Bergveld, Kluwer Academic Publishers, 2000 pp. 311-314; Tiensuu et al., “Hydrophobic Valves by Ink-Jet Printing on Plastic CDs with Integrated Microfluidics,” Micro Total Analysis Systems 2000, A. van den Berg, W. Olthuis, P. Bergveld, Kluwer Academic Publishers, 2000 pp. 575-578; Madou et al., “A Centrifugal Microfluidic Platform—A Comparison,” Micro Total Analysis Systems 2000, A. van den Berg, W. Olthuis, P. Bergveld, Kluwer Academic Publishers, 2000 pp. 565-570; Zeng et al., “Design Analysis of Capillary Burst Valves in Centrifugal Microfluidics,” Micro Total Analysis Systems 2000, A. van den Berg, W. Olthuis, P. Bergveld, Kluwer Academic Publishers, 2000 pp. 579-582; Badr et al., “Fluorescent Ion-Selective Optode Membranes Incorporated onto a Centrifugal Microfluidics Platform,” Analytical Chemistry, Vol. 74, No. 21, pp. 5569-5575, November 2002; Johnson et al., “Development of a Fully Integrated Analysis System for Ions Based on Ion-Selective Optodes and Centrifugal Microfluidics,” Analytical Chemistry, Vol. 73, No. 16, pp. 3940-3946, August 2001; McNeely et al., “Hydrophobic Microfluidics,”, Proc. Microfluidic Devices and Systems, SPIE, Vol. 3877, pp. 210-220, 1999; Application Report 101, Gyrolab MALDA SP1, Gyros AB, Uppsala, Sweden; Kellogg et al., “Centrifugal Microfluidics: Applications,” Micro Total Analysis Systems 2000, van den Berg et al., Kluwer Academic Publishers, 2000 pp. 239-242; Thomas et al., “Integrated Cell Based Assays in Microfabricated Disposable CD Devices,” Micro Total Analysis Systems 2000, van den Berg et al., Academic Publishers, 2000 pp. 249-252; Duffy et al., “Microfabicated Centrifugal Microfluidic Systems: Characterization and Multiple Enzymatic Assays,” Analytical. Chemistry, Vol. 71, No. 20, pp. 4669-4678, 1999).

As described above, the microfluid structures 110 are in fluid communication with one or more pumps 115. The pump 115 acts to direct fluid flow in a direction opposite to that generated by centrifugal force or in a direction radially inward from the periphery of the disc to the center of the disc. This permits fluid flow along additional areas of the disc than would be permitted with flow only in the radially outward direction. Thus, there is an effective increase in usable surface area for sample manipulation and preparation steps. With respect to the diagram in FIG. 2, the pump 115 is fluidly connected to reservoir 210 located near the outer edge of the platform 101. The pump 115 generates a pressure or force that directs fluid flow out of the first reservoir 210 through conduit 215 toward a second reservoir 220 located near the center of the platform 101. The direction of fluid flow generated by the pump 115 is identified in FIG. 2 by arrows F₂ and F₄.

Various mechanisms can be employed to provide a force that directs fluid flow in the counter-centrifugal direction. The mechanism by which the pump 115 acts to direct fluid flow in a counter-centrifugal direction can include, but is not limited to, chemical, electrochemical, electrolytic, electro-osmotic, and electrophoretic pumping. Similarly, various mechanisms can be employed to direct fluid flow in the counter-centrifugal direction through the desired channels. In an embodiment, the dimensions of the channel leading out of the reservoir can be larger than the channel leading to the reservoir thereby resulting in pressure from the pump pushing the fluid in the counter-centrifugal direction and through the desired channel in the circuit. In another embodiment, the entrance of the electrolysis pump “gas” channel can be closer to the top of the chamber so that fluid is pushed out of the reservoir in the desired direction and through the desired channel. Additional electrolytic pumps can be added to provide valving. Also, balancing pressures from multiple pumps acting on the same channels can also direct fluid into the desired channel.

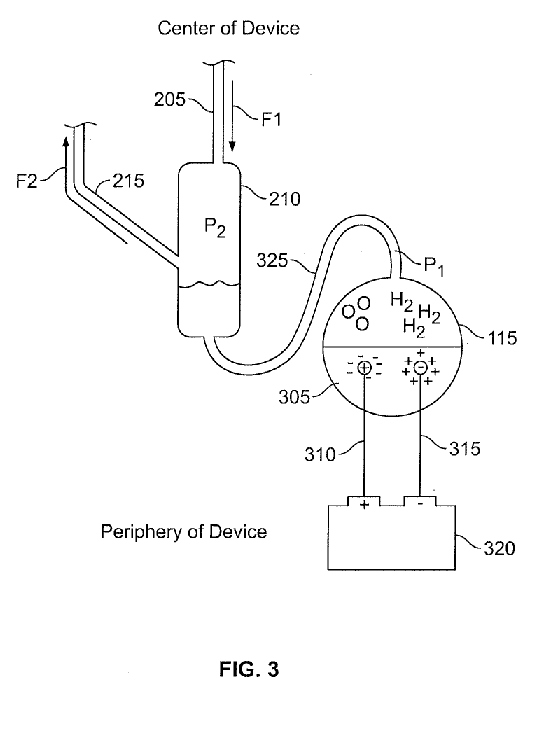

FIG. 3 illustrates schematically how fluid can be pumped in a counter-centrifugal direction by an electrochemical pump. The principle of the electrochemical pumping involves electrolysis of water into hydrogen and oxygen gases. The evolved gasses from the pump pressurizes sample in a reservoir downstream of the pump and returns the sample toward the center of the disc, i.e. against centrifugal force. Additional on-disc pumping (and/or valving) using in situ evolved gases enables the sample at the edge or perimeter of the disc to be returned to its center through a different channel thereby allowing for repeated centrifugal pumping of the fluid. The pumping mechanism is relatively insensitive to fluid composition of the sample in contrast to AC and DC electrokinetic means of pumping. Aqueous solutions, solvents (e.g. DMSO), surfactants, and biological fluids (including blood, milk, and urine) can be pumped successfully.

With respect to FIG. 3, upon application of an electrical current between a pair of inert electrodes immersed in a substrate 305, the positively charged anode 310 and the negatively charged cathode 315 attract ions of the opposite charge. The energy required to separate the ions, and cause them to gather at the respective electrodes, can be provided by an electrical power supply 320. If the substrate 305 is water, hydrogen gas collects at the cathode 315 and oxygen gas collects at the anode 310. The pump 115 is in fluid connection with the reservoir 210. As more hydrogen and oxygen gas evolves, a pressure differential is generated between the pump well 115 and the reservoir 210. Once the pressure P₁ inside the pump chamber 115 is higher than the pressure P₂ inside the reservoir 210, sample in the reservoir 210 flows radially inward through a second conduit 215 away from the periphery of the disc, i.e. in a direction counter to the centrifugal force shown by arrow F₂. Although the pump 115 is in fluid communication with the reservoir 210, it is a “closed” system in that fluid transported by centrifugal action does not enter the pump 115. Similarly, the fluid flow occurs through a conduit 215 that is distinct from the conduit 205 through which the fluid initially traveled in the radially-outward direction. Fluid continues to move through the microfluidic structures in the device without back-tracking and without entering the pump system.

The substrate 305 can be, for example, water, an electrolyte or other appropriate liquid solution such as a sodium chloride or potassium nitrate solution or other substrate, such as a solid substrate. The electrodes 310, 315 can be metal, for example, platinum or other appropriate metal. The electrodes 310, 315 can be screen printed on a supporting acrylic disc or thin wires can be inserted and epoxied into the disc from its edge. The connection between the electrodes 310, 315 and the power supply 320 can occur, for example, via brush contacts pressed onto the disc (as shown in FIG. 1). Alternatively, the electrodes can be energized on demand using an on-disc power source (embedded electronics and a battery). The contacts to the electrodes can be made directly when disc rotation stops. In one embodiment, the electric contacts to each disc layer and pump on each layer can be achieved using a long single contact embedded into the edge of the disc. Electrical current in the range of 10-100 mA can be applied to the electrodes 310, 315 and a voltage in the range of 5-10V can generate sufficient evolution of gases to pump fluid in a counter-centrifugal direction.

On-disc pumping enables the device to be used for procedures requiring a multitude of steps. In another embodiment of the device, the platforms are stacked such that flow through the microfluid structures occurs in a three-dimensional manner. Multilayered, three-dimensional compact discs (3DCDs) significantly increase the available surface area on a disc for sample manipulation and preparation steps. Embedded on-disc pumping allows bi-directional and three-dimensional fluid transport, in turn, enabling unlimited pumping combinations through the device. The 3DCD system enables continuous centrifugal pumping and vertical fluidic communication between stacked discs. An on-CD pumping mechanism such as electrochemically generated pressure in the microchannels returns the fluid to the center of the disc and allows repeated centrifugal pumping on subsequent discs.

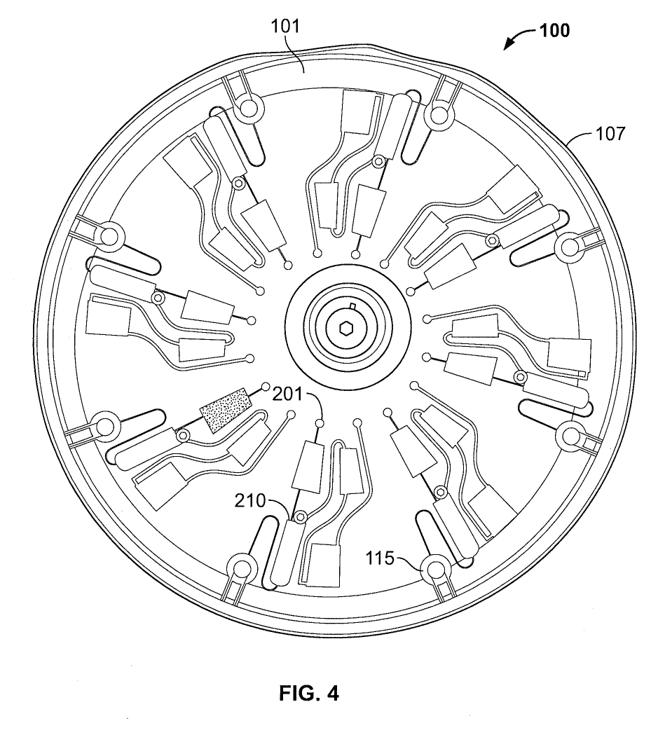

FIG. 4 shows an exemplary 3DCD device 100. In an embodiment, the 3DCD device can be fabricated using polydimethylsiloxane (PDMS) CD technology (as described in Example 1). Several PDMS layers are patterned with fluidic channels and assembled or joined using thin acrylic discs. The electrolytic pumps 115 are shown embedded at the edge of the disc for counter-centrifugal pumping. Acrylic discs inserted between the two or more PDMS layers can have imprinted fluidic structures. Flow through one disc to the next can be achieved by drilling small holes (0.5-1.5 mm diameter) in the acrylic thereby connecting the discs at appropriate locations connecting the fluidic channels from one disc to the next.

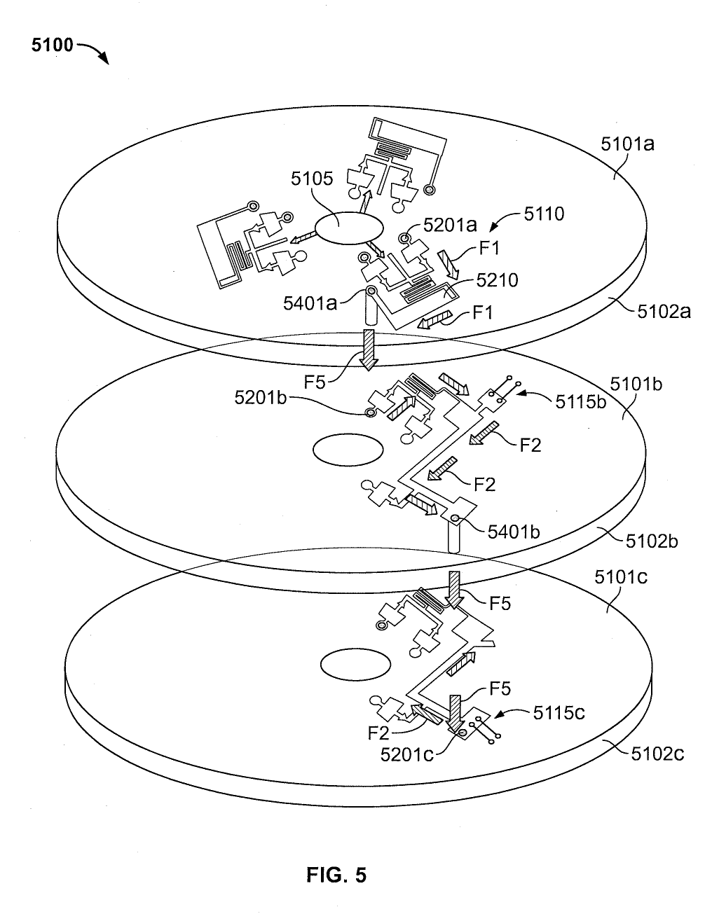

FIG. 5 shows an exploded schematic diagram of an embodiment of the device. In this embodiment, multiple platforms (5101a, 5101b, 5101c) are stacked to form a 3DCD device 5100. The platforms 5101 are in fluid connection with one another, but separated by support structures 5102a, 5102b, 5102c. The platforms 5101 generally include one or more microfluid structures 5110 fluidly connected to one or more pumps 5115. The microfluid structures 5110 are arranged from an inner position to an outer position in relation to the rotational axis of the device 5100 and extend radially from the hole 5105 located at the center of the device 5100. Rotation of the device 5100 results in fluid flow through the microfluid structures 5110 towards the outer edges of the platforms 5101, as represented by arrows F₁. Rotation of the device 5100 also results in fluid flow between the platforms 5101 in a downward direction, as represented by arrows F₅.

The schematic of FIG. 5 shows an exemplary path of sample through the device 5100. An inlet port 5201a is generally located near the center of the top platform 5101a. Sample applied to the inlet port 5201a flows through the microchannel structures 5110 of the top platform 5101a in response to the centrifugal force generated by spinning the device 5100. Sample makes its way through the microchannel structures 5110 to reservoir 5210 in a direction that is generally outward in relation to the axis of rotation. Sample can flow into an exit port 5401a in the top platform 5101a, through a hole in the support structure 5102a and into an inlet port 5201b of the second platform 5101b.

At some point the sample reaches the periphery of the platform and can be pumped in a counter-centrifugal direction (shown in the figure as arrow F₂). The on-disc pump 5115b pumps the fluid away from the periphery of the platform 5101b, as described above. This primes the second platform 5101b such that sample can again flow through microchannel structures 5110 in response to centrifugal force. Sample can flow into an exit port 5401b in the microchannel structures 5110 of the second platform 5101b such that it flows downward through the support structure 5102b and into an inlet port 5201c of the third platform 5101c. Centrifugal forces direct fluid movement generally outward as well as downward to the next platform. The pump directs fluid movement generally inward or counter-centrifugally. Movement of the sample through the microfluid structures can thereby continue indefinitely.

Manufacture and Materials of the Device

Exemplary fabrication techniques of the device are described in Example 1 including the fabrication of PDMS CDs, fabrication of CDs using dry-laminated photoresist, and fabrication of machined and laminated polycarbonate discs. The device can be made in a disposable format to integrate cheaply with other analytic procedures.

The device can be manufactured from inorganic or organic material. Typical inorganic materials can include, but are not limited to silicon, quartz, glass etc. Typical organic materials can include, but are not limited to plastics including elastomers, such as rubber silicone polymers (for instance polydimethylsilicone, PDMS) etc. Materials selected for manufacture of the devices described herein have properties of interest, such as hydrophobic properties, low self-fluorescence, or are materials that are translucent or transparent. Plastic materials that can be used include polycarbonate, polystyrene and plastic material based on monomers which consist of a polymerizable carbon-carbon double or triple bonds and saturated branched straight or cyclic alkyl and/or alkylene groups.

The device can be in the form of a disc with the microfluid structures extending in a plane parallel or substantially parallel to the disc plane. The device can be the same dimension as a conventional CD or stack of CDs, but can also be smaller, for example down to 10% of conventional CDs, or larger, up to more than 200% or more the 400% of a conventional CD. Percentage values refer to the radius. The disc thickness can be about 0.5-2 mm to 10-20 mm for a multilayer disc structure.

Typically, open microstructures are formed in the surface of a planar substrate by various techniques such as etching, laser ablation, lithography, replication, embossing, molding, casting etc. Each substrate material typically has its preferred techniques. The microstructures can be designed such that when the surfaces of two planar substrates are opposed the desired enclosed microchannel structure is formed between the two substrates. Separate moldings can be assembled together such as by heating to provide a closed structure with openings at defined positions to allow loading of the device with fluids and removal of fluid samples or waste. With respect to the 3DCD stack, multiple discs can be separated from each other by a plastic layer, such as acrylic. Fluid connections between discs can be maintained by drilling ports through the separation layers.

The surface of channels and reservoirs can be modified, such as by chemical or physical means to alter surface properties, for example, to produce localized regions of hydrophobicity or hydrophilicity to confer a desired flow property. Surfaces of the open microchannel structures can be hydrophilised, for instance as described in WO 00/56808 (Gyros AB). The inner surface can then be coated with a non-ionic hydrophilic polymer as described in WO 00/56808 (Gyros AB). Hydrophobic surface breaks can also be introduced as outlined in WO 99/58245 (Gyros AB) to control flow. See also WO 01/85602 (Amic AB & Gyros AB).

### EXAMPLES

### Example 1

### CD Fabrication Techniques

Fabrication of PDMS CDs—

Polydimethylsiloxane (PDMS) used for preparation of microfluidic devices for biomedical applications involves molding of the polymer onto photolithographically created templates—the so-called soft lithography process. SU-8 photolithography is a good choice for fabricating a master mold allowing fabrication of channels and structures with features as high as or greater than about 500 μm. For the CD fabrication, the SU-8 process was adapted to achieve the desired multilayer (3-D) PDMS fluidic structures that provide sufficient surface area.

Preparation of the Exposure Mask—

Different fluidic patterns including inlet and waste reservoirs as well as pathways and chambers were designed using AutoCAD drawing program. A transparency foil was printed using very high resolution printers and appropriate black and white patterning (3,600 dpi). This simple mask and exposure procedure was sufficient to create CD channel features as small as 25 μm.

SU-8 Mold Fabrication—

SU-8 is a negative tone photoresist that has attracted interest for the fabrication of high aspect ratio features and for applications requiring very thick photoresist layers. Due to its UV transparency, standard UV lithography can be used to craft LIGA-like MEMS devices. SU-8 photoresists come in different viscosities: the lower viscosity products are more suited for the fabrication of thin structures down to 2 μm while the more viscous SU-8 resists are better suited for thick layers up to millimeters. XP SU-8-100, XP SU8-50F and SU-8 25, available from Microchem Inc. (Newton, Mass.), were tested for the CD development. SU-8 50 and SU-8 100 were found to provide best properties to create CD microchannel structures with appropriate height. SU-8 50 and 100 were processed on a 6″ reclaimed Si wafer (Addison Engineering, San Jose, Calif.) to obtain the structures for the microchannels between 50 μm and up to 250 μm in depth, depending on the spin-coating rate. The silicon wafer was first plasma cleaned (oxygen/argon plasma: O2; time=5 min; 100 mTorr pressure, power 200 W). Subsequently, a thick layer of SU-8 photoresist was spin-coated (Bid Tec Spin Coater, Model SP 100) over the wafer substrate (thick layers ca 100 μm: 1,000 rpm, 120 s or 2,500 rpm, 120 s for thinner films). The SU-8 photoresist was oven baked at 95° C. for 3-4 hours and evacuated to remove volatiles. The postbaking step can be critical for good adhesion between the substrate and the crosslinked SU-8 structures. Insufficient postbaking and exposure can cause the structures to peel off during development.

Exposure and Development of the Photoresist Mold—

The silicon wafer coated with SU-8 film was positioned on the aligner and exposed to UV through the transparency mask with appropriate fluidic patterns covering the entire disc (AB-M High Performance Table Top Alignment and Exposure System, 500 W mercury lamp), Typical exposure times were 1,500 mJ for 100-120 seconds. The exposed SU-8 mold was post-baked at 95° C. for 15 minutes and developed in XP SU-8 PEGMA developer (3 times). The wafer was washed in de-ionized water, dried with purified nitrogen and under vacuum for 15 minutes.

Polymerization Molding of PDMS CDs—

Polydimethylsiloxane was purchased from Dow Corning (Midland, Mich.). The base (Sylguard 184 silicone elastomer) and the curing agent (silicone resin solution) were thoroughly mixed in a weight proportion of 10:1. The mixture was de-gassed under vacuum for 30-45 minutes to avoid bubble formation. The silicone resin was weighed and poured over the patterned SU-8 coated wafer and spin-coated to obtain the uniform thickness. The disc shape was maintained using a plastic ring attached to the wafer. Low temperature curing (e.g. 65° C.) in a convection oven was preferred over high temperature baking due to the high thickness of the structures. High temperature (e.g. 150° C.) causes significant thermal stress at the interface between the SU-8 patterns and the Si substrate which can actually crack the substrate and peel off the SU-8 structures. Precise leveling of the PDMS on the substrate was applied to achieve a uniform thickness of the fluidic channels. The coated substrate was then cooled down gradually in an oven until its temperature decreased below 50° C. This step was intended to reduce residual stress in the pattern and at the Si/pattern interface. Development took about 50 min. The PDMS was unclamped from the wafer and the rotating CD disc was completed by sandwiching the PDMS sheet between two polycarbonate discs in the clean room.

Fabrication of CDs Using Dry-Laminated Photoresist

In a second method developed for the fabrication of the CD fluidic discs, a dry film photoresist (DF 8130, Think & Tinker, Palmer Lake, Colo.) was laminated onto a 1 mm thick polycarbonate disc with pre-drilled holes for sample introduction. The microfluidic pattern was made using a photolithographic pattern on the negative photoresist. This photoresist was exposed and developed in a similar manner as the PDMS discs. The fluidic system was capped with a polycarbonate disc that had been laminated with an optical quality pressure sensitive adhesive (3M 8142, 3M, Minneapolis, Minn.).

Fabrication of Machined and Laminated Polycarbonate Discs

For high sensitivity applications such as infectious disease detection, larger volumes of the samples may be needed to be able to extract and concentrate the targeted pathogen sample. CDs can be fabricated by machining the fluidic patterns in the acrylic materials and laminating with thin acrylic disc using pressure sensitive adhesives to enclose the fluidic channels.

### Example 2

### Counter-Centrifugal On-CD Pumping

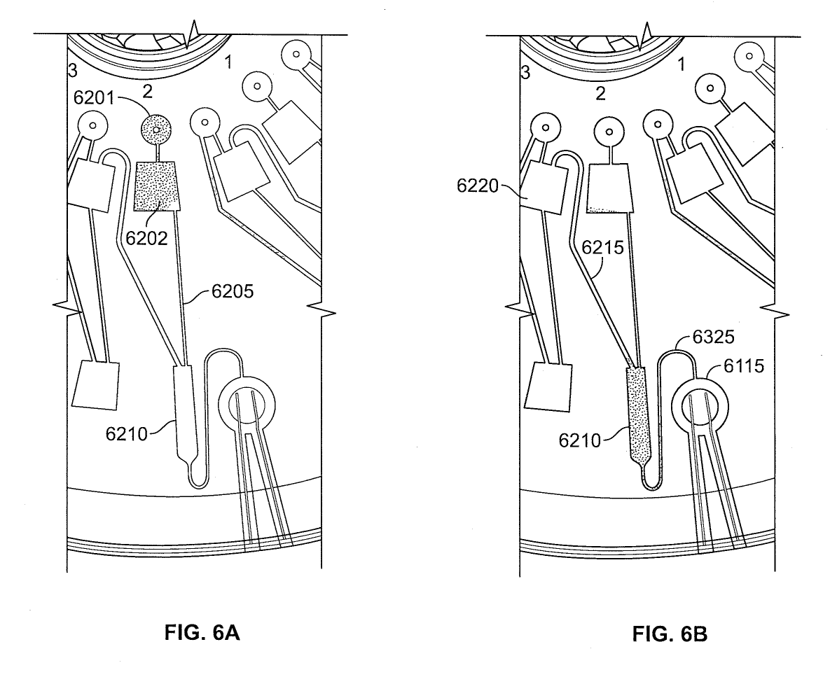

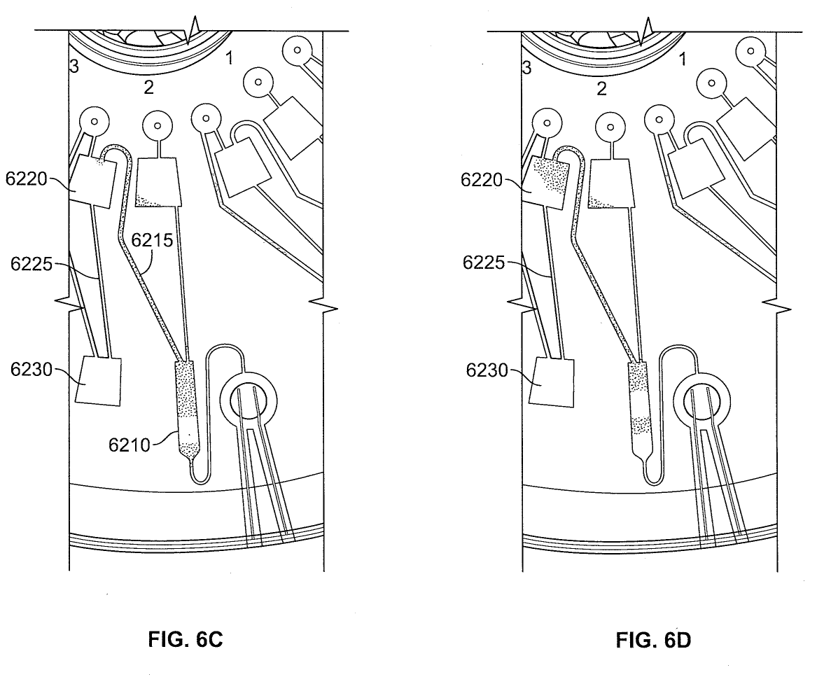

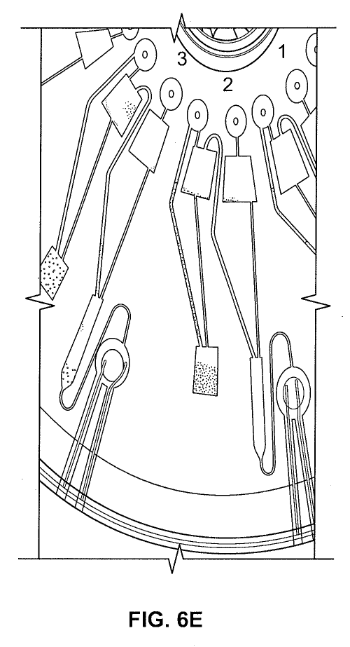

FIGS. 6A-6E show a series of photographs demonstrating the operation of the on-CD electrochemical pumps in combination with centrifugal pumping and demonstrate fluid flow through the channels and chambers of the 3DCD device. The 3DCDs were fabricated using PDMS soft lithography technology as described in Example 1. To create 3D structures, acrylic discs were inserted between two or more PDMS substrates with imprinted fluidic structures. The flow through one disc to the other PDMS layer was achieved by drilling small holes (0.5-1.5 mm diameter) in the acrylic connecting discs at appropriate locations connecting the fluidic channels from one layer to the next layer. The PDMS layers were plasma cleaned as necessary and assembled with acrylic discs in the clean room to avoid particles embedding in the disc channels.

The electrochemical pump on the 3DCDs was a simple well filled with a small amount of electrolyte (20-50 microliters of 0.05-0.1 M potassium nitrate) and with two platinum electrodes embedded in the wells. The electrolysis of water into hydrogen and oxygen gases at the electrodes pressurized the sample to be transported in the fluidic reservoirs positioned down flow in the microchannels allowing for on-demand, on-CD, counter-centrifugal pumping. The sample was centrifugally pumped to the edge reservoirs, back to the disc center as well as downward through holes in the acrylic support structure and into a chamber of the next disc in the 3DCD stack.

The discs making up the 3DCD stack were each 4.72″ in diameter and had eight 50 microliter pump wells embedded at the edge of the disc. This allowed for multiple samples to be tested on the disc simultaneously. The pump-wells were 0.2″ in diameter and centered 0.65″ from the edge of the disc at a spread of 360 between them. The vent holes and sample addition holes were 0.025″ to 0.0465″ in diameter.

Now with respect to FIGS. 6A-6E, sample was introduced into the chamber 6202 through a sample injection port 6201 near the center of the top disc (FIG. 6A). Optimum spin-coater setting used to perform device rotation and was in the range 10-20 seconds @ 1,000 RPM. This was an optimal range for the device rotation speed and time for the centrifugal force to push the sample out of chamber 6202 through channel 6205 toward the next chamber 6210 near the edge of the top disc (FIG. 6B). Evolved gases in conduit 6325 produced by the electrochemical pump 6115 returned the sample through channel 6215 into chamber 6220 (FIGS. 6C and 6D). Due to the transparent nature of the layers of the 3DCD device, the chambers and conduits of the second disc appear to be located on the top disc. However, chamber 6220 is located near the center of the second disc. Subsequent rotation of the 3DCD device was used to continue sample transport through the 3DCD device, toward the edge of the second disc to the next chamber 6230 through channel 6225 (FIG. 6E). It was found that for the 0.05 M-0.1 M potassium nitrate electrolyte, for very low voltage applied, in the range 5-10 V, currents in the range 10-100 mA could be obtained. It was found that by adjusting the voltage and current reproducible pumping rates were obtained. It was possible to pump fluid controllably in intervals ranging from 10-100 seconds.

As certain changes may be made without departing from the scope of the present subject matter described herein, it is intended that all matter contained in the above description or shown in the accompanying drawings be interpreted as illustrative and not in a literal sense (and thus, not limiting). Practitioners of the art will realize that the method, device and system configurations depicted and described herein are examples of multiple possible system configurations that fall within the scope of the current subject matter described herein.

While the subject matter described herein has been described with reference to the specific embodiments thereof, it should be understood by those skilled in the art that various changes may be made and equivalents may be substituted without departing from the true spirit and scope of the subject matter described herein. In addition, many modifications may be made to adapt a particular situation, material, composition of matter, process, process step or steps, to the objective and scope of the subject matter described herein. All such modifications are intended to be within the scope of the claims appended hereto.

Throughout this application, various publications, patents and published patent applications may be cited. The disclosures of these publications, patents and published patent applications referenced in this application are hereby incorporated by reference in their entirety into the present disclosure. Citation herein by the Applicant of a publication, published patent application, or patent is not an admission by the Applicant of said publication, published patent application, or patent as prior art. Accordingly, all publications and patents cited in this specification are herein incorporated by reference as if each individual publication or patent were specifically and individually indicated to be incorporated by reference.

While this specification contains many specifics, these should not be construed as limitations on the scope of an invention that is claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications and enhancements to the described examples and implementations and other implementations may be made based on what is disclosed.

What is claimed is:

1. A device, comprising:
a platform having an axis of rotation, wherein the platform comprises:
(a) one or more fluidic structures, wherein each fluidic structure comprises:
(i) an inlet port near the axis of rotation;
(ii) a first reservoir located away from the axis of rotation; and
(iii) a second reservoir located near the axis of rotation, wherein the first reservoir is in fluid communication with the inlet port via a first conduit and the first reservoir is in fluid communication with the second reservoir via a second conduit; and
(b) one or more pumps in fluid communication with the one or more fluidic structures via a third conduit;
wherein fluid loaded in the inlet port moves through the first conduit to the first reservoir by centrifugal force arising from the platform rotating around the axis, and wherein the fluid moves from the first reservoir through the second conduit to the second reservoir by a counter-centrifugal force generated by the pump, and wherein fluid movement toward the first reservoir comprises movement away from the axis of rotation and fluid movement toward the second reservoir comprises movement toward the axis of rotation.

2. The device of claim 1, wherein the one or more fluidic structures are microfluidic structures.

3. The device of claim 2, wherein the one or more microfluidic structures are arranged radially on a single platform.

4. The device of claim 3, comprising at least 10 microfluidic structures arranged radially on a single platform.

5. The device of claim 1, wherein the platform is optically transparent.

6. The device of claim 1, wherein the platform is a circular disk.

7. The device of claim 1, comprising more than one platform.

8. The device of claim 7, wherein the platforms are stacked vertically.

9. The device of claim 8, wherein a first platform of the vertical stack is in fluid communication with a second platform of the vertical stack.

10. The device of claim 9, wherein fluid movement through the fluidic channels is three-dimensional.

11. The device of claim 1, wherein the one or more pumps comprise chemical, electrochemical, electrolytic, and electroosmotic pumps.

12. A method of preparing a sample for analysis, comprising:
rotating a platform about its axis of rotation to generate a centrifugal force, wherein the platform comprises an axis of rotation, one or more fluidic structures, and one or more pumps in fluid communication with the one or more fluidic structures, and wherein the sample is loaded in an inlet port near the axis of rotation; and
generating a pressure differential within the one or more fluidic structures to move the sample toward the axis of rotation through the one or more fluidic structures against the centrifugal forces generated by rotating the platform.

13. The method of claim 12, further comprising:
rotating simultaneously more than one platform, wherein the more than one platforms are in fluid communication with each other.

14. The method of claim 13, wherein the platforms are stacked vertically.

15. The method of claim 14, wherein rotating simultaneously the vertical stack of platforms moves fluid through the fluidic structures three-dimensionally.

16. A method for preparing a sample for analysis, comprising:
loading a sample into the inlet port of the device of claim 1;
rotating the device about its axis of rotation to move the sample through the first conduit to the first reservoir located away from the axis of rotation by centrifugal force arising from the device rotating around the axis; and
creating a counter-centrifugal force with the pump to move the sample from the first reservoir through the second conduit to the second reservoir located near the axis of rotation.
